(19) United States
(12) Patent Application Publication
(10) Pub. No.: US 2026/0368963 A1
(43) Pub. Date: Nov. 19, 2026

(54) BODY-PARTITIONED ENCODING FOR FULL-BODY PRESERVATION

(71) Applicant: ADOBE INC., SAN JOSE, CA (US)

(72) Inventors: Jisu Nam, Seoul (KR); Zhan Xu, San Jose, CA (US); Jing Shi, San Jose, CA (US); Difan Liu, San Jose, CA (US); Feng Liu, Beaverton, OR (US); Yang Zhou, Mountain View, CA (US)

(21) Appl. No.: 19/212,163

(22) Filed: May 19, 2025

(51) Int. Cl. G06T 11/60; G06T 5/60; G06T 5/70; G06V 10/26; G06V 10/774; G06V 10/82; G06V 40/10

(52) U.S. Cl. CPC G06T 11/60; G06T 5/60; G06T 5/70; G06V 10/273; G06V 10/7747; G06V 10/82; G06V 40/10; G06T 2207/30196

(57) ABSTRACT

A method, apparatus, non-transitory computer readable medium, and system for generating images of a subject with full-body preservation includes obtaining an input image and an input text. The input image depicts the subject, and the input text describes a scene. Embodiments then generate, using a body-partitioned transformer of an image generation model, a plurality of body part identity embeddings corresponding to body parts of the subject. The body part identity embeddings encode full-body spatial details as well as fine-level details. Embodiments then generate, using the image generation model, a synthetic image based on the plurality of body part identity embeddings and the input text. The synthetic image depicts the subject in the scene described by the input text.

### BACKGROUND

The following relates generally to image processing, and more specifically to image generation. Image processing is a type of data processing that involves the manipulation of an image to get the desired output, typically utilizing specialized algorithms and techniques. It is a method used to perform operations on an image to enhance its quality or to extract useful information from it. This process usually comprises a series of steps that includes the importation of the image, its analysis, manipulation to enhance features or remove noise, and the eventual output of the enhanced image or salient information it contains.

Image generation is a type of image processing that involves the creation of synthetic images. Recently, generative artificial intelligence (AI) models have been developed to generate realistic images. For example, denoising diffusion models generate samples by transforming an initial random noise distribution into a data distribution over a series of time steps. Some denoising diffusion models can be conditioned on a text description, such that the diffusion process generates images that match the text.

### SUMMARY

Embodiments of the present disclosure include systems and methods for generating images of a subject with full-identity preservation. Embodiments include an encoding system trained to generate dense embeddings from an input image of a subject, referred to herein as “body part identity embeddings.” The body part identity embeddings encode visual characteristics from different parts of the subject. They are used by an image generation model along with an input text to generate a synthetic image of the subject that faithfully adheres to the identity of the subject, including face, clothing, and accessory details. Embodiments include an image encoder configured to segment the input image, identity different body regions, and encode each region to generate body part image embeddings. Then, embodiments process the body part image embeddings using a custom a body-partitioned transformer that generates a plurality of body part identity embeddings. The body part identity embeddings preserve detailed local features from each body region while maintaining spatial relationships across the subject's full appearance.

These dense embeddings are generated through a multi-stage process involving cross-attention to map localized features to corresponding identity tokens, followed by self-attention to refine the intra-relationships between features. When combined with text descriptions that specify a desired scene or context, these embeddings enable the generation of synthetic images that faithfully reproduce the subject's complete visual identity while integrating them into new scenes, environments, and styles as directed by the input text.

A method, apparatus, non-transitory computer readable medium, and system for image generation are described. One or more aspects of the method, apparatus, non-transitory computer readable medium, and system include obtaining an input image and an input text, wherein the input image depicts a subject and the input text describes a scene; generating, using a body-partitioned transformer of an image generation model, a plurality of body part identity embeddings corresponding to body parts of the subject; and generating, using the image generation model, a synthetic image based on the plurality of body part identity embeddings and the input text, wherein the synthetic image depicts the subject in the scene described by the input text.

A method, apparatus, non-transitory computer readable medium, and system for image generation are described. One or more aspects of the method, apparatus, non-transitory computer readable medium, and system include obtaining an input image and an input text, wherein the input image depicts a subject and the input text describes a scene; performing a body part cross-attention operation based on the input image; performing a text cross-attention operation based on the input text; and generating, using an image generation model, a synthetic image based on an output of the body part cross-attention operation and an output of the text cross-attention operation, wherein the synthetic image depicts the subject in the scene described by the input text.

An apparatus, system, and method for image generation are described. One or more aspects of the apparatus, system, and method include a memory component; a processing device coupled to the memory component, the processing device configured to perform operations comprising: obtaining an input image and an input text, wherein the input image depicts a subject and the input text describes a scene; generating, using a body-partitioned transformer of an image generation model, a plurality of body part identity embeddings corresponding to body parts of the subject; and generating, using the image generation model, a synthetic image based on the plurality of body part identity embeddings and the input text, wherein the synthetic image depicts the subject in the scene described by the input text.

### BRIEF DESCRIPTION OF THE DRAWINGS

FIG. 1 shows an example of an image processing system according to aspects of the present disclosure.

FIG. 2 shows an example of an image processing apparatus according to aspects of the present disclosure.

FIG. 3 shows an example of a Transformer architecture according to aspects of the present disclosure.

FIG. 4 shows an example of a guided latent diffusion model according to aspects of the present disclosure.

FIG. 5 shows an example of a U-Net architecture according to aspects of the present disclosure.

FIG. 6 shows an example of a diffusion transformer (DiT) architecture according to aspects of the present disclosure.

FIG. 7 shows an example of an operation of an image encoder according to aspects of the present disclosure.

FIG. 8 shows an example of an operation of a body-partitioned transformer according to aspects of the present disclosure.

FIG. 9 shows an example of an image generation pipeline according to aspects of the present disclosure.

FIG. 10 shows an example of a method for generating a synthetic image of a subject with full-body preservation according to aspects of the present disclosure.

FIG. 11 shows an example of results of various text prompts and a single input image according to aspects of the present disclosure.

FIG. 12 shows an example of comparative results according to aspects of the present disclosure.

FIG. 13 shows an example of a step-by-step flow diagram for training machine learning (ML) models according to aspects of the present disclosure.

FIG. 14 shows an example of a method for training a diffusion model according to aspects of the present disclosure.

FIG. 15 shows an example of a computing device according to aspects of the present disclosure.

### DETAILED DESCRIPTION

Image processing techniques, such as image generation, are frequently used in creative workflows. For example, in some cases, a user may wish to pose a subject or generate additional images of the subject in a certain style. Historically, users would rely on manual techniques and drawing software to create such visual content. The advent of machine learning (ML) has enabled new workflows that automate the image creation process. These ML-based workflows can significantly reduce the time and technical expertise required to produce complex visual content, allowing creators to focus more on ideation and less on manual execution.

ML is a field of data processing that focuses on building algorithms capable of learning from and making predictions or decisions based on data. It includes a variety of techniques, ranging from simple linear regression to complex neural networks, and plays a significant role in automating and optimizing tasks that would otherwise require extensive human intervention.

Image generation models use ML techniques to create new images based on various inputs. Recent advancements in diffusion models have enabled high-quality image synthesis from text descriptions. These models learn to gradually denoise random patterns into coherent images that match input prompts. The quality and realism of generated images has improved dramatically. These advancements have enabled new applications in creative industries, entertainment, and design.

One challenge in image generation is creating images of specific subjects that maintain their visual identity across different contexts. Traditional models excel at generating novel content but struggle to faithfully reproduce the appearance of particular individuals, objects, or characters. This limitation becomes apparent when attempting to place a specific subject in new environments or scenarios while preserving their distinct visual characteristics.

Some conventional methods for subject preservation in image generation rely on semantic representations from pre-trained image encoders. These approaches extract global features from reference images using vision-language models or facial recognition systems. The extracted features are then mapped to compact identity embeddings through linear projection layers. These embeddings guide the image generation process to incorporate the subject's appearance while following text prompts that describe the desired scene. Many existing approaches compress these representations into a small number of tokens, typically around 16, to condition the generation model.

Other conventional methods focus on specialized techniques for specific domains. Some approaches target face-specific preservation by using dedicated facial recognition embeddings. Alternative methods employ subject-specific fine-tuning, which requires retraining parts of the model for each new subject. Text-based approaches attempt to describe the subject's appearance explicitly in detailed prompts.

However, these conventional methods can fail to preserve the complete visual identity of subjects. Global feature mapping often loses fine-grained details about clothing, accessories, and body-specific characteristics. Many approaches focus primarily on facial identity preservation while neglecting full-body appearance consistency. This limitation becomes especially apparent when generating images of subjects in new poses, environments, or activities. The resulting images may retain facial similarity but fail to maintain consistent clothing details, accessories, or other elements that constitute the subject's complete visual identity. Additionally, techniques that use simplified token representations often blend local details from different body parts, resulting in poor full-body appearance preservation.

Embodiments of the present disclosure, by contrast, improve the accuracy of image generation systems. For example, embodiments more accurately generate new synthetic images of a subject that are faithful to the subject's identity, as given from an input image. Embodiments include an encoding system trained to generate dense embeddings from an input image of a subject, referred to herein as “body part identity embeddings.” These embeddings encode visual characteristics from different parts of the subject. A body-partitioned transformer processes segmented body regions independently before integrating them, a process that preserves fine-grained details that might otherwise be lost. The system's cross-attention mechanism establishes explicit mappings between specific body parts in the input and output images, while self-attention refines relationships between features. These embeddings are used by an image generation model along with an input text to generate a synthetic image of the subject that faithfully adheres to the identity of the subject, including face, clothing, and accessory details.

As used herein, “body part identity embeddings” refer to dense numerical representations that encode visual characteristics of specific body regions of a subject. These embeddings are latent vector representations, in the form of vectors or multi-dimensional tensors, which capture detailed appearance information including clothing patterns, accessories, and other distinctive visual elements. They are generated by processing segmented body regions through neural network components, including transformers that apply attention mechanisms to preserve local details. Body part identity embeddings are used as conditioning inputs to guide image generation models in accurately reproducing a subject's full appearance.

As used herein, “pretrained body part embeddings” (sometimes referred to as “initial body part embeddings”) refer to foundational vector representations of body regions that have been established through prior training on large datasets. They are a starting point for body part identity processing and include learned representations of common body structures, typical clothing arrangements, and general appearance features. Some examples of “pretrained body part embeddings” include learned template embeddings for a feet region, a pants region, a torso region, and a head region. The body-partitioned transformer processes these pretrained embeddings at inference by performing cross-attention with input image features and further performing self-attention to produce the final body part identity embeddings.

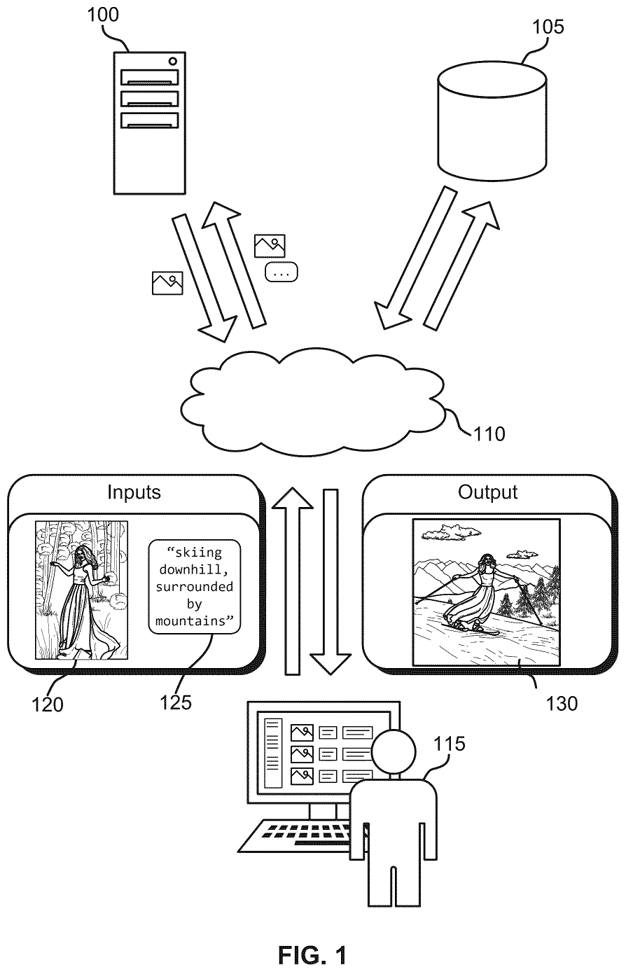

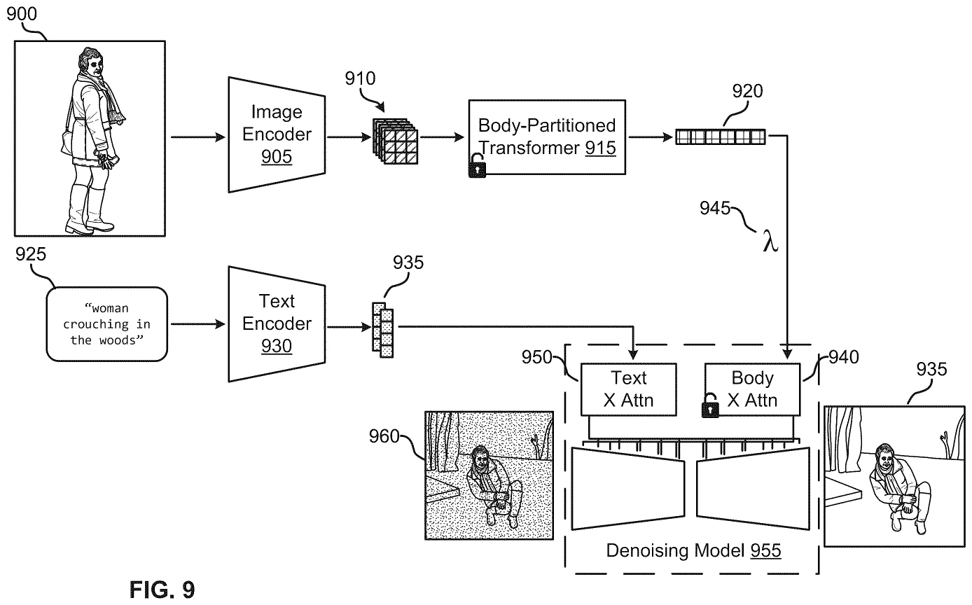

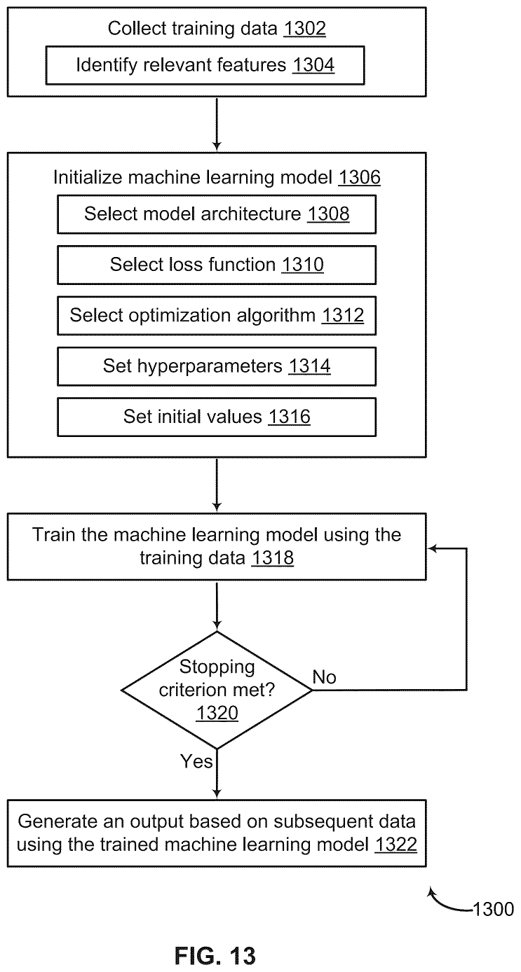

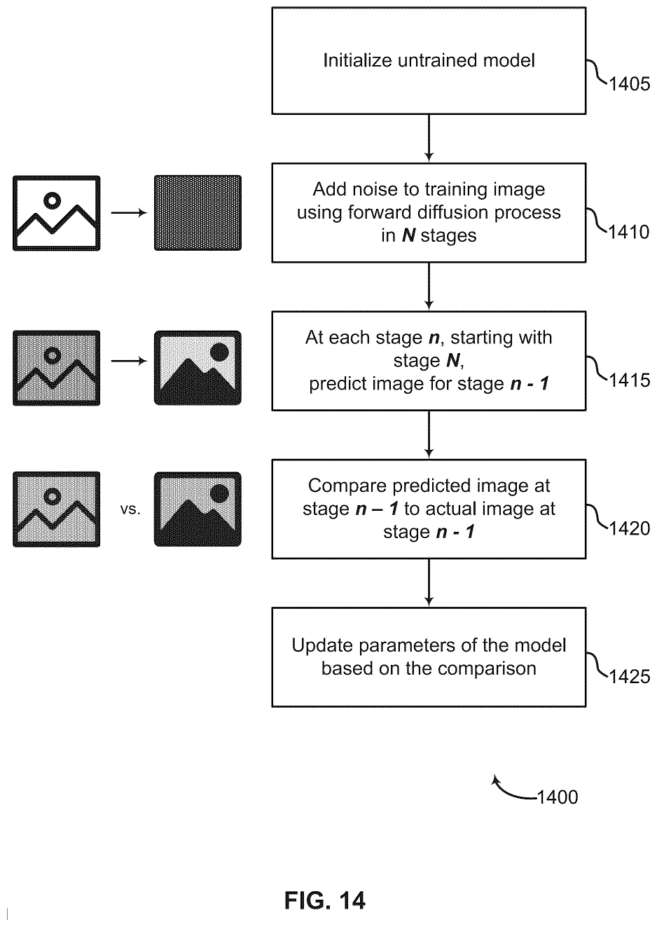

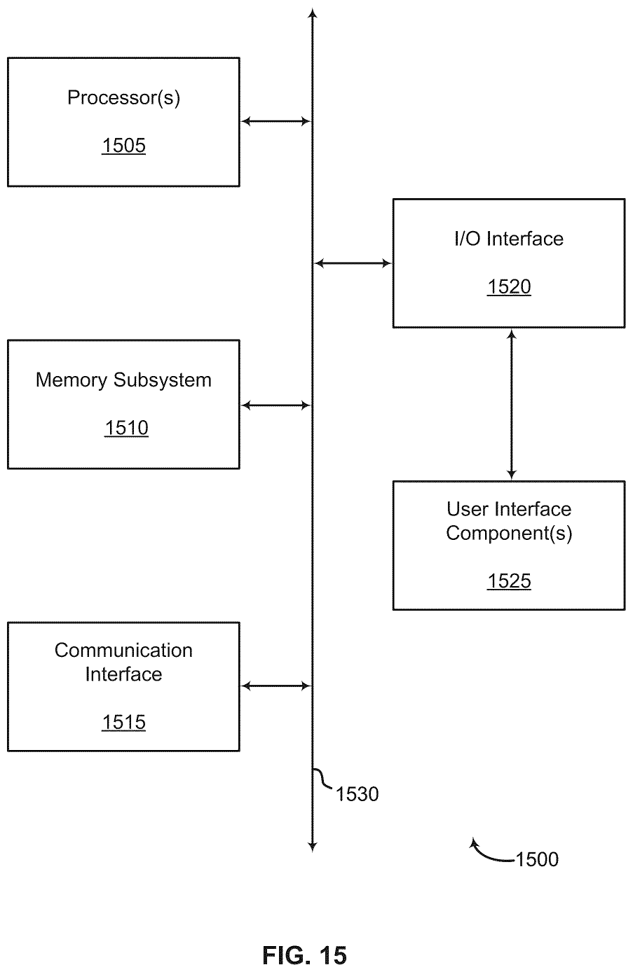

An image processing system is described with reference to FIGS. 1-8. Pipelines and methods for generating synthetic images of a subject with full-identity preservation, as well as results of the generation, are described with reference to FIGS. 9-12. Training methods are described with reference to FIGS. 13-14. A computing device configurable to implement an image generation apparatus is described with reference to FIG. 15.

### Image Processing System

FIG. 1 shows an example of an image processing system according to aspects of the present disclosure. The example shown includes image processing apparatus 100, database 105, network 110, user 115, input image 120, input text 125, and synthetic image 130.

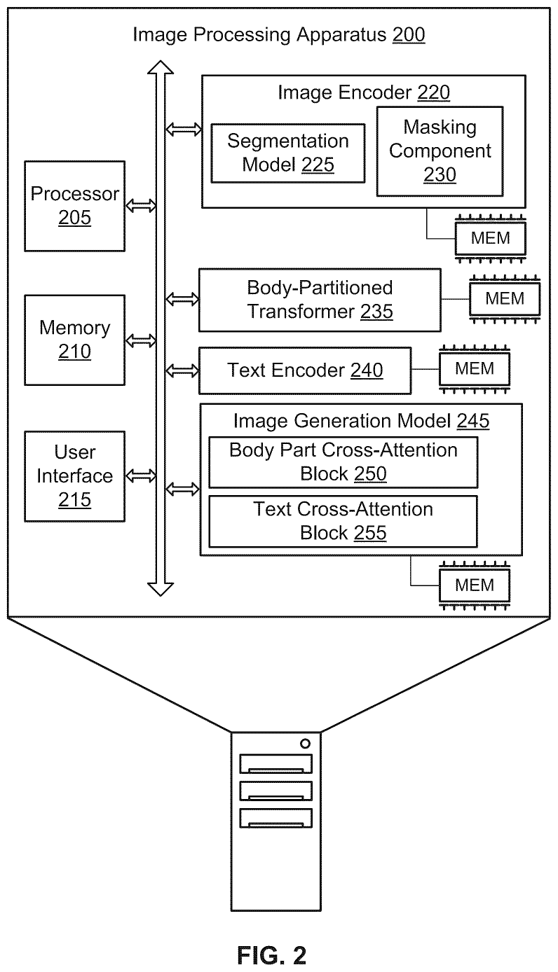

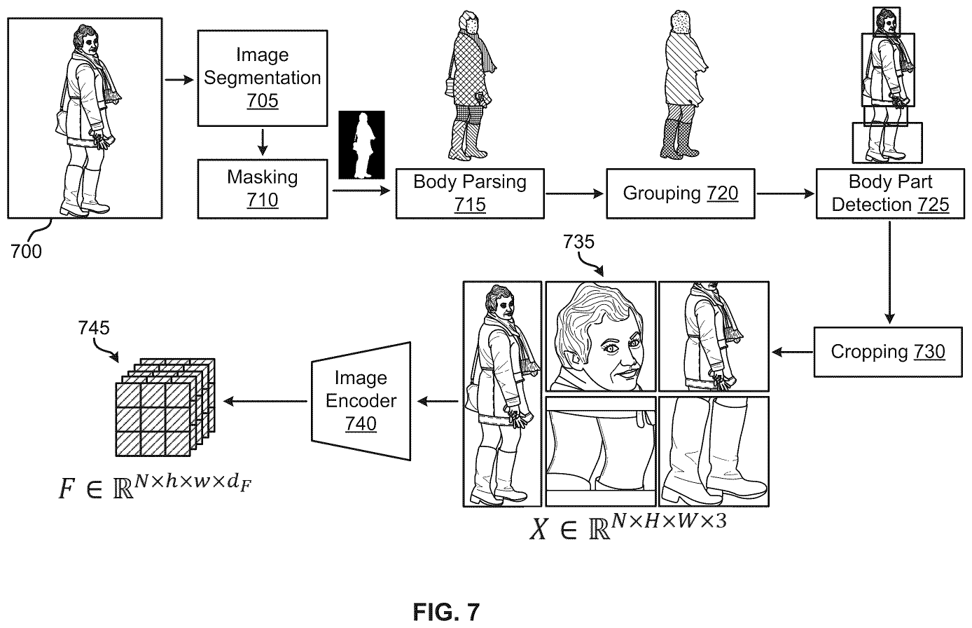

Image processing apparatus 100 is an example of, or includes aspects of, the corresponding element described with reference to FIG. 2. Input image 120 is an example of, or includes aspects of, the corresponding element described with reference to FIGS. 7, 9, 11, and 12. Input text 125 is an example of, or includes aspects of, the corresponding element described with reference to FIG. 9. Synthetic image 130 is an example of, or includes aspects of, the corresponding element described with reference to FIG. 9.

In an example process, user 115 wishes to portray a subject in a different scene. User 115 provides input image 120 which depicts the subject, as well as input text 125 which describes the scene. The image processing apparatus 100 processes the inputs and generate synthetic image 130. In this example, synthetic image 130 depicts the woman from input image 120 skiing on a mountain. The whole body identity of the woman is preserved across input image 120 and synthetic image 130, including facial details, clothing, accessories, and the like.

In some embodiments, one or more components of image processing apparatus 100 are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a super computer, or any other suitable processing apparatus.

Database 105 is configured to store information used by the image processing system. For example, database 105 may store model parameters, generated images, generated videos, intermediate representations and embeddings, user configuration settings, activity history, model training data, and the like. A database is an organized collection of data. For example, a database stores data in a specified format known as a schema. A database may be structured as a single database, a distributed database, multiple distributed databases, or an emergency backup database. In some cases, a database controller may manage data storage and processing in a database. In some cases, a user interacts with the database controller. In other cases, the database controller may operate automatically without user interaction.

Network 110 facilitates the transfer of information between image processing apparatus 100, database 105, and user 115. In some cases, network 110 is referred to as a “cloud”. A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

FIG. 2 shows an example of an image processing apparatus 200 according to aspects of the present disclosure. The example shown includes image processing apparatus 200, processor 205, memory 210, user interface 215, image encoder 220, body-partitioned transformer 235, text encoder 240, and image generation model 245.

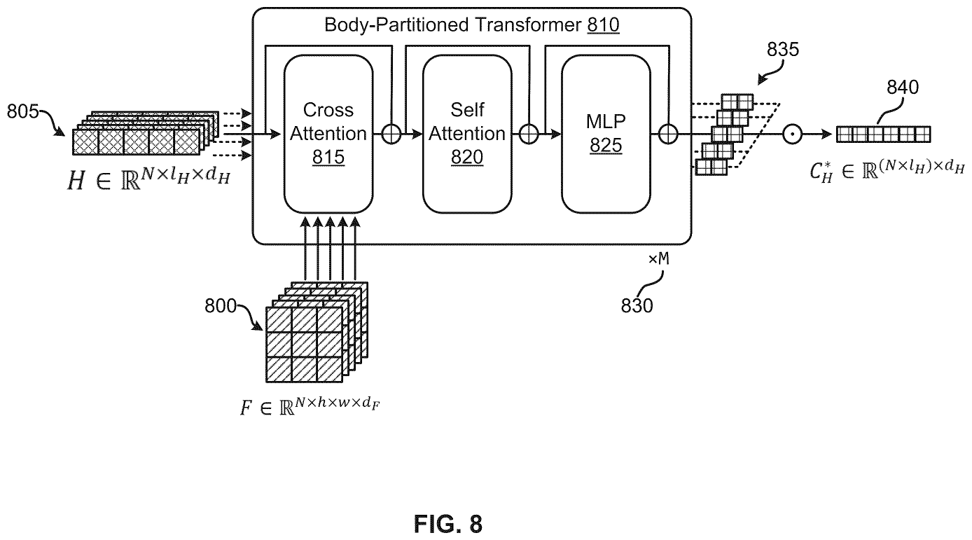

Image processing apparatus 200 is an example of, or includes aspects of, the corresponding element described with reference to FIG. 1. Image encoder 220 is an example of, or includes aspects of, the corresponding element described with reference to FIGS. 7 and 9. Body-partitioned transformer 235 is an example of, or includes aspects of, the corresponding element described with reference to FIGS. 8 and 9. Text encoder 240 is an example of, or includes aspects of, the corresponding element described with reference to FIG. 9.

Body part cross-attention block 250 is an example of, or includes aspects of, the corresponding element described with reference to FIG. 9. Text cross-attention block 255 is an example of, or includes aspects of, the corresponding element described with reference to FIG. 9.

A processor 205 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor 205 is configured to operate a memory array using a memory controller. In other cases, a memory controller is integrated into processor 205. In some cases, processor 205 is configured to execute computer-readable instructions stored in memory 210 to perform various functions. In some embodiments, processor 205 includes special purpose components for modem processing, baseband processing, digital signal processing, or transmission processing.

Memory 210 stores information used in the operation of image processing apparatus 200. Examples of a memory device include random access memory (RAM), read-only memory (ROM), or a hard disk. Examples of memory devices include solid state memory and hard disk drives. In some examples, memory 210 is used to store computer-readable, computer-executable software including instructions that, when executed, cause processor 205 to perform various functions described herein. In some cases, the memory 210 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 210 store information in the form of a logical state.

According to some aspects, some components of the image processing apparatus 200 may include dedicated memories as indicated by the ‘MEM’ elements in FIG. 2. These dedicated memories may store model parameters that, when combined with mathematical operations executed by processor 205, cause the corresponding components to perform the functions described herein. In some embodiments, the dedicated memories are implemented as non-transitory computer-readable mediums. The parameters may be stored statically or configured at runtime. For example, adjustments to the parameters may be made during pretraining processes, finetuning processes, or user-configuration processes such as hot-swapping different models. In certain implementations, these specialized memory structures enable hardware-accelerated execution of complex computational functions through purpose-built circuitry optimized for specific operations, thereby transforming the general-purpose computing device into a specialized machine uniquely configured to perform the particular image processing operations described herein. The dedicated memories may be coupled with specialized processing units, such as tensor processing units or neural processing units, which implement custom data paths specifically designed to execute the mathematical operations required by the image processing components.

A user interface 215 enables a user to interact with image processing apparatus 200. In some embodiments, user interface 215 includes an audio device, such as an external speaker system, an external display device such as a display screen, or an input device (e.g., remote control device interfaced with the user interface 215 directly or through an IO controller module). In some cases, user interface 215 includes a graphical user interface (GUI).

Image encoder 220 is configured to segment an input image into a plurality of regions and to encode each region into “body part image embeddings.” Embodiments include a pretrained model for segmentation, and a pretrained encoder model for generating the body part image embeddings. The image encoder processes each body region independently and may not perform cross-attention between regions. This independent encoding creates vector representations that capture localized visual information such as textures, patterns, colors, and structural elements specific to each body part. The embeddings preserve spatial information from the input and are used as inputs to body-partitioned transformer 235 for further processing.

In one aspect, image encoder 220 includes segmentation model 225 and masking component 230. In digital image processing and computer vision, image segmentation is the process of partitioning a digital image into multiple segments (sets of pixels, also known as image objects). The goal of segmentation is to simplify and/or change the representation of an image into something that is more meaningful and easier to analyze. Image segmentation is typically used to locate objects and boundaries (lines, curves, etc.) in images. More precisely, image segmentation is the process of assigning a label to every pixel in an image such that pixels with the same label share certain characteristics. In digital image processing and computer vision, image segmentation is the process of partitioning a digital image into multiple segments (sets of pixels, also known as image objects). The goal of segmentation is to simplify and/or change the representation of an image into something that is more meaningful and easier to analyze. Image segmentation is typically used to locate objects and boundaries (lines, curves, etc.) in images. More precisely, image segmentation is the process of assigning a label to every pixel in an image such that pixels with the same label share certain characteristics. The masking component 230 may generate a mask image that includes pixel values that indicate a background region and a subject region. According to some aspects, the mask image may be used as an additional guidance signal to the body-partitioned transformer 235 during the generation of the body part identity embeddings, or to the image generation model 245 during the generation of the synthetic image.

According to some aspects, image encoder 220 segments the input image to obtain a set of body part images, where the set of body part identity embeddings are generated based on the set of body part images, respectively. Embodiments of image encoder 220 include a vision transformer (ViT) model.

A transformer or transformer network is a type of neural network model used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a.

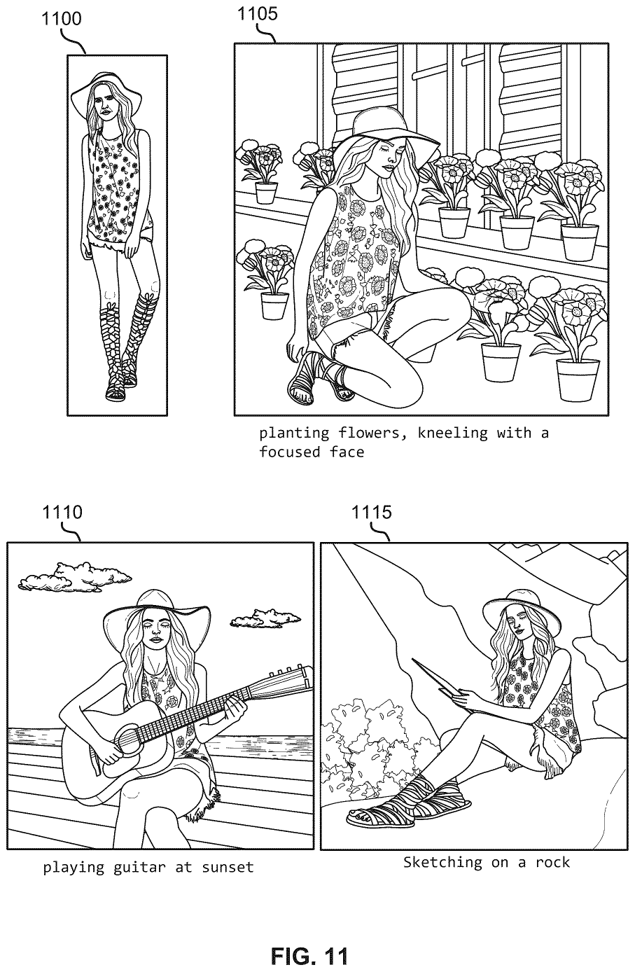

A vision transformer (e.g., a ViT model) is a neural network model configured for computer vision tasks. Unlike CNNs, ViTs use a transformer architecture, which was originally developed for natural language processing (NLP) tasks. ViTs break down an input image into a sequence of patches, which are then fed through a series of transformer encoder layers. The output of the final encoder layer is fed into a multi-layer perceptron (MLP) head for classification. ViTs can capture long-range dependencies between patches without relying on spatial relationships. The detail extractor model described with reference to FIG. 11 may include a ViT model.

Body-partitioned transformer 235 is configured to generate body part identity embeddings, which are dense numerical representations that encode visual characteristics of specific body regions of the subject. This component processes the body part image embeddings through a series of cross-attention and self-attention operations. The cross-attention operations map localized features from each body region to corresponding identity tokens, while the self-attention operations refine the intra-relationships between these features. This approach preserves fine-grained details such as clothing patterns, accessories, and facial identity while establishing spatial relationships between different body parts. Additional detail regarding a body-partitioned transformer model is provided with reference to FIG. 8.

Text encoder 240 is configured to generate a text embedding that may be used to condition the generative process of image generation model 245. The text encoder processes the input text through tokenization, which converts the text into discrete tokens that can be numerically represented. These tokens are then processed through a Transformer-based architecture to generate contextual embeddings that capture semantic meaning. Various pretrained models may be used as the text encoder, including language models such as Flan-T5, the CLIP text encoder, GPT-2, or GPT-3. The resulting text embedding represents the scene description provided by the user and guides the image generation model to produce a synthetic image that accurately depicts the described scene.

In one aspect, image generation model 245 includes body part cross-attention block 250 and text cross-attention block 255. In at least one embodiment, image generation model 245 further includes image encoder 220 and body-partitioned transformer 235, forming an image generation pipeline.

Body part cross-attention block 250 is configured to perform a cross-attention operation between the body part identity embeddings and intermediate outputs from the denoising model of image generation model 245. This operation allows the denoising model to attend to specific body part features when generating the corresponding regions in the output image. By using separate cross-attention operations for body parts, the model can accurately map visual characteristics from the input subject to appropriate locations in the synthetic image and thereby maintain identity consistency across different poses and contexts.

Text cross-attention block 255 is configured perform a cross-attention operation between the text embedding and intermediate outputs from the denoising model of image generation model 245. This operation enables the denoising model to incorporate semantic information from the text description when generating the synthetic image. The text cross-attention operations guide the overall scene composition, background elements, and subject positioning in accordance with the input text. Text cross-attention block 255 may work in parallel with body part cross-attention block 250. The text cross-attention directs scene-level attributes while the body part cross-attention preserves identity-specific details. This separation allows the model to generate images that simultaneously follow text instructions and maintain subject identity.

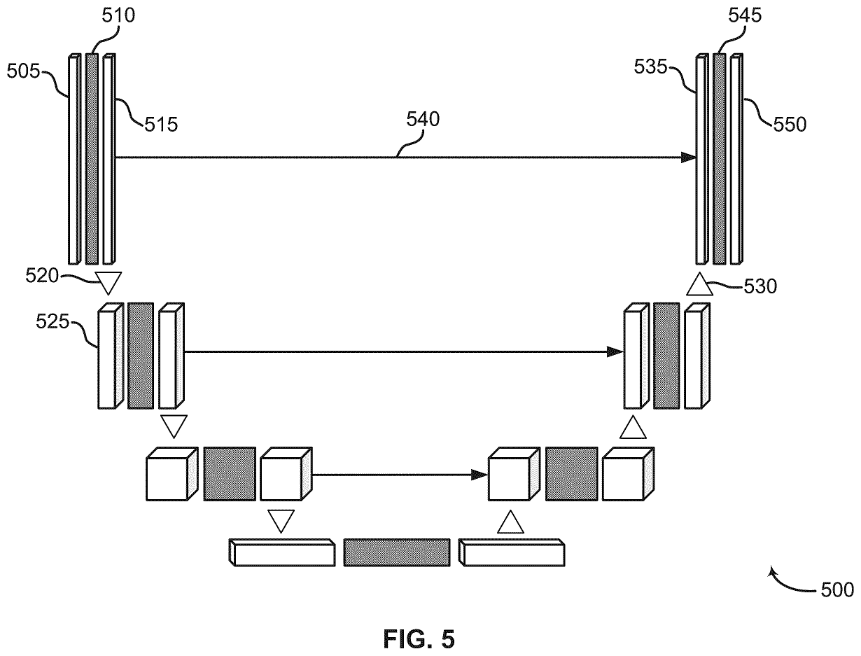

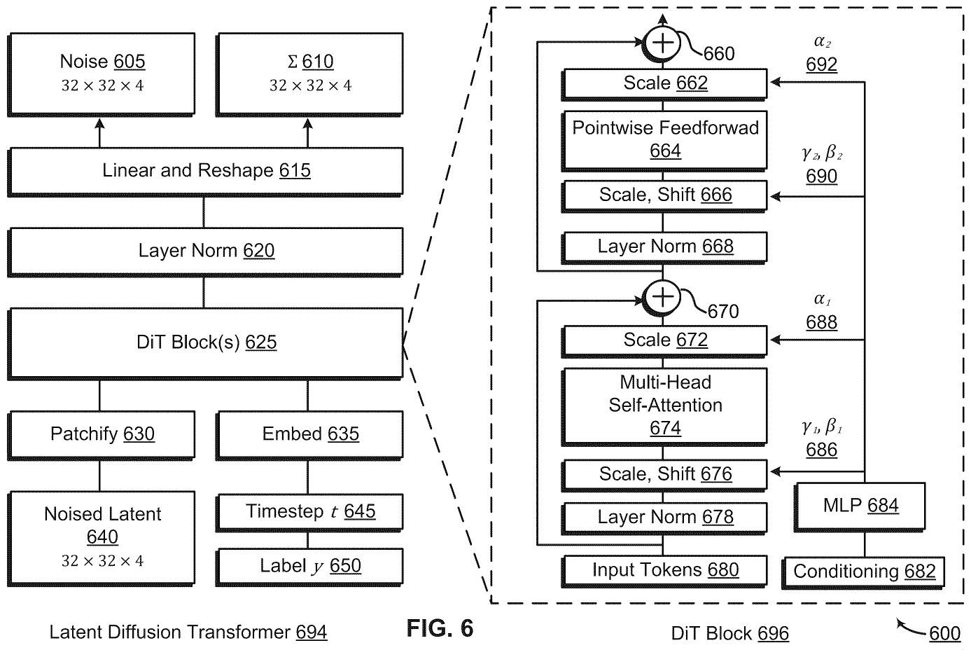

According to some aspects, image generation model 245 generates a synthetic image based on the set of body part identity embeddings and the input text, where the synthetic image depicts the subject in the scene described by the input text. In some examples, image generation model 245 performs a body part cross-attention operation based on the set of body part identity embeddings, where the synthetic image is generated based on an output of the body part cross-attention operation. In some examples, image generation model 245 performs a text cross-attention operation based on the input text, where the synthetic image is generated based on an output of the text cross-attention operation. In some examples, image generation model 245 obtains a noise input. This noise input may be a sample from a pixel space or a latent space. In some examples, image generation model 245 denoises the noise input based on the input text and the set of body part identity embeddings. In some aspects, the image generation model 245 is trained by segmenting a training input image into a set of training body part images. In some aspects, the image generation model 245 includes a denoising diffusion model. Examples of denoising diffusion models will be described in detail with reference to FIGS. 5 and 6.

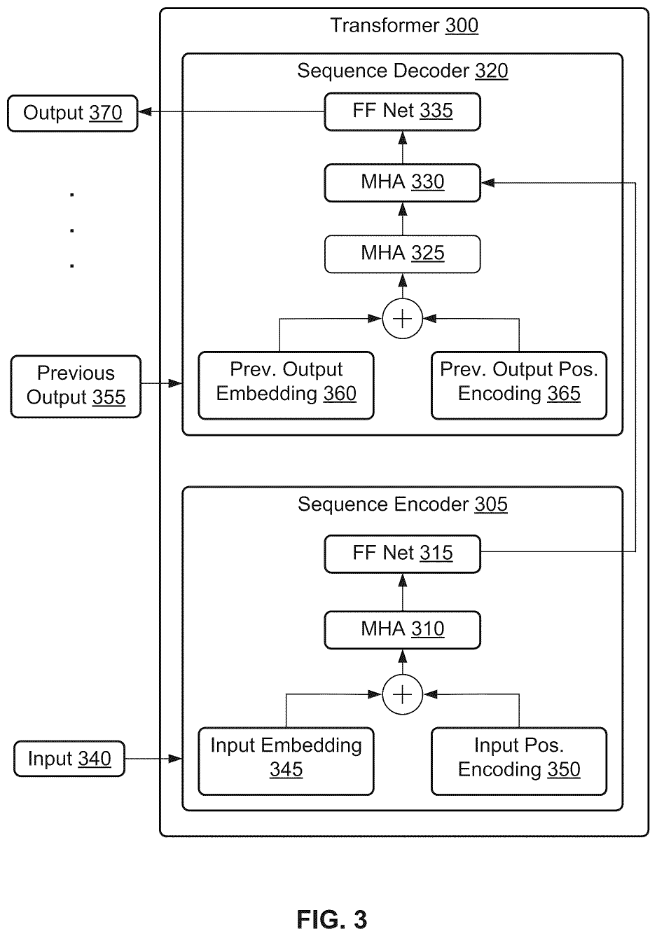

FIG. 3 shows an example of a transformer network according to aspects of the present disclosure. In some embodiments, transformer networks are used in the image encoder, the body-partitioned transformer, the text encoder, or the denoising model of the image generation model as described herein. The example shown includes transformer 300, encoder 305, decoder 320, input 340, input embedding 345, input positional encoding 350, previous output 355, previous output embedding 360, previous output positional encoding 365, and output 370.

In some cases, encoder 305 includes multi-head self-attention sublayer 310 and feed-forward network sublayer 315. In some cases, decoder 320 includes first multi-head self-attention sublayer 325, second multi-head self-attention sublayer 330, and feed-forward network sublayer 335.

According to some aspects, a machine learning model (such as the language generation model(s) and the multimodal language model described with reference to FIG. 2) comprises transformer 300. In some cases, encoder 305 is configured to map input 340 (for example, a query or a prompt comprising a sequence of words or tokens) to a sequence of continuous representations that are fed into decoder 320. In some cases, decoder 320 generates output 370 (e.g., a prediction of an output sequence of words or tokens) based on the output of encoder 305 and previous output 355 (e.g., a previously predicted output sequence), which allows for the use of autoregression.

For example, in some cases, encoder 305 parses input 340 into tokens and vectorizes the parsed tokens to obtain input embedding 345, and adds input positional encoding 350 (e.g., positional encoding vectors for input 340 of a same dimension as input embedding 345) to input embedding 345. In some cases, input positional encoding 350 includes information about relative positions of words or tokens in input 340.

In some cases, encoder 305 comprises one or more encoding layers (e.g., six encoding layers) that generate contextualized token representations, where each representation corresponds to a token that combines information from other input tokens via self-attention mechanism. In some cases, each encoding layer of encoder 305 comprises a multi-head self-attention sublayer (e.g., multi-head self-attention sublayer 310). In some cases, the multi-head self-attention sublayer implements a multi-head self-attention mechanism that receives different linearly projected versions of queries, keys, and values to produce outputs in parallel. In some cases, each encoding layer of encoder 305 also includes a fully connected feed-forward network sublayer (e.g., feed-forward network sublayer 315) comprising two linear transformations surrounding a Rectified Linear Unit (ReLU) activation:

FFN(x)=ReLU(W₁x+b₁)W₂+b₂ (1)

In some cases, each layer employs different weight parameters (W₁, W₂) and different bias parameters (b₁, b₂) to apply a same linear transformation to each word or token in input 340. As described with reference to FIG. 2, a multimodal encoder may generate tokens interpretable by the transformer from data of different modalities, such as image data, sound data, and video data. A connector network may project these tokens into the same embedding space as other modalities, e.g., the tokens representing text.

In some cases, each sublayer of encoder 305 is followed by a normalization layer that normalizes a sum computed between a sublayer input x and an output sublayer(x) generated by the sublayer:

layernorm(x+sublayer(x)) (2)

In some cases, encoder 305 is bidirectional because encoder 305 attends to each word or token in input 340 regardless of a position of the word or token in input 340.

In some cases, decoder 320 comprises one or more decoding layers (e.g., six decoding layers). In some cases, each decoding layer comprises three sublayers including a first multi-head self-attention sublayer (e.g., first multi-head self-attention sublayer 325), a second multi-head self-attention sublayer (e.g., second multi-head self-attention sublayer 330), and a feed-forward network sublayer (e.g., feed-forward network sublayer 335). In some cases, each sublayer of decoder 320 is followed by a normalization layer that normalizes a sum computed between a sublayer input x and an output sublayer(x) generated by the sublayer.

In some cases, decoder 320 generates previous output embedding 360 of previous output 355 and adds previous output positional encoding 365 (e.g., position information for words or tokens in previous output 355) to previous output embedding 360. In some cases, each first multi-head self-attention sublayer receives the combination of previous output embedding 360 and previous output positional encoding 365 and applies a multi-head self-attention mechanism to the combination. In some cases, for each word in an input sequence, each first multi-head self-attention sublayer of decoder 320 attends only to words preceding the word in the sequence, and so transformer 300's prediction for a word at a particular position only depends on known outputs for a word that came before the word in the sequence. For example, in some cases, each first multi-head self-attention sublayer implements multiple single-attention functions in parallel by introducing a mask over values produced by the scaled multiplication of matrices Q and K by suppressing matrix values that would otherwise correspond to disallowed connections.

In some cases, each second multi-head self-attention sublayer implements a multi-head self-attention mechanism similar to the multi-head self-attention mechanism implemented in each multi-head self-attention sublayer of encoder 305 by receiving a query Q from a previous sublayer of decoder 320 and a key K and a value V from the output of encoder 305, allowing decoder 320 to attend to each word in the input 340.

In some cases, each feed-forward network sublayer implements a fully connected feed-forward network similar to feed-forward network sublayer 315. In some cases, the feed-forward network sublayers are followed by a linear transformation and a softmax function to generate a prediction of output 370 (e.g., a prediction of a next word or token in a sequence of words or tokens).

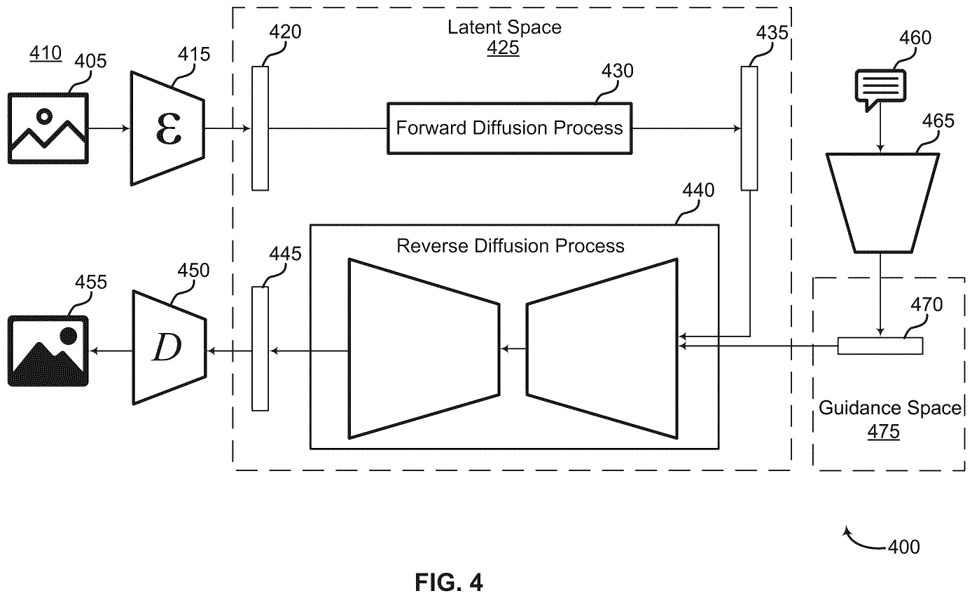

FIG. 4 shows an example of a guided latent diffusion model 400 according to aspects of the present disclosure. The guided latent diffusion model 400 depicted in FIG. 4 is an example of, or includes aspects of, the image generation model 245 described with reference to FIG. 2.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 400 may take an original image 405 in a pixel space 410 as input and apply and image encoder 415 to convert original image 405 into original image features 420 in a latent space 425. Then, a forward diffusion process 430 gradually adds noise to the original image features 420 to obtain noisy features 435 (also in latent space 425) at various noise levels.

Next, a reverse diffusion process 440 (e.g., a U-Net ANN or a DiT ANN) gradually removes the noise from the noisy features 435 at the various noise levels to obtain denoised image features 445 in latent space 425. In some examples, the denoised image features 445 are compared to the original image features 420 at each of the various noise levels, and parameters of the reverse diffusion process 440 of the diffusion model are updated based on the comparison. Finally, an image decoder 450 decodes the denoised image features 445 to obtain an output image 455 in pixel space 410. In some cases, an output image 455 is created at each of the various noise levels. The output image 455 can be compared to the original image 405 to train the reverse diffusion process 440.

In some cases, image encoder 415 and image decoder 450 are pre-trained prior to training the reverse diffusion process 440. In some examples, they are trained jointly, or the image encoder 415 and image decoder 450 and fine-tuned jointly with the reverse diffusion process 440.

The reverse diffusion process 440 can also be guided based on a text prompt 460, or another guidance prompt, such as an image, a layout, a segmentation map, etc. The text prompt 460 can be encoded using a text encoder 465 (e.g., a multimodal encoder) to obtain guidance features 470 in guidance space 475. The guidance features 470 can be combined with the noisy features 435 at one or more layers of the reverse diffusion process 440 to ensure that the output image 455 includes content described by the text prompt 460. For example, guidance features 470 can be combined with the noisy features 435 using a cross-attention block within the reverse diffusion process 440.

FIG. 5 shows an example of a U-Net architecture according to aspects of the present disclosure. In some examples, U-Net 500 is an example of the component that performs the reverse diffusion process 440 of guided diffusion model 400 described with reference to FIG. 4 and includes architectural elements of the image generation model 245 described with reference to FIG. 2. The U-Net 500 depicted in FIG. 5 is an example of, or includes aspects of, the architecture used within the reverse diffusion process described with reference to FIG. 4.

In some examples, diffusion models are based on a neural network architecture known as a U-Net. The U-Net 500 takes input features 505 having an initial resolution and an initial number of channels and processes the input features 505 using an initial neural network layer 510 (e.g., a convolutional network layer) to produce intermediate features 515. The intermediate features 515 are then down-sampled using a down-sampling layer 520 such that down-sampled features 525 have a resolution less than the initial resolution and a number of channels greater than the initial number of channels.

This process is repeated multiple times, and then the process is reversed. That is, the down-sampled features 525 are up-sampled using up-sampling process 530 to obtain up-sampled features 535. The up-sampled features 535 can be combined with intermediate features 515 having a same resolution and number of channels via a skip connection 540. These inputs are processed using a final neural network layer 545 to produce output features 550. In some cases, the output features 550 have the same resolution as the initial resolution and the same number of channels as the initial number of channels.

In some cases, U-Net 500 takes additional input features to produce conditionally generated output. For example, the additional input features could include a vector representation of an input prompt. The additional input features can be combined with the intermediate features 515 within the neural network at one or more layers. For example, a cross-attention module can be used to combine the additional input features and the intermediate features 515.

FIG. 6 shows an example of a diffusion transformer (DiT) architecture according to aspects of the present disclosure. While some generative diffusion models are based on a convolutional layer backbone (e.g., the U-Net), others may be based on a transformer network backbone. The DiT illustrated in FIG. 6 is a component of, or includes aspects of, the denoising model 245 described with reference to FIG. 2.

The example shown includes predicted noise 605, predicted covariance 610, linear and reshape layers 615, normalization layer 620, DiT block(s) 625, patchify operation 630, embedding 635, noised latent 640, timestep information 645, label information 650, and an implementation of one block in the DiT block(s) 625 by a DiT Block 696. The DiT Block 696 includes: second residual connection 660, second scaling operations 662, feed-forward network 664, post-normalization second scaling and shifting 666, second normalization 668, first residual connection 670, first scaling operations 672, self-attention 674, post-normalization first scaling and shifting 676, first normalization 678, input tokens 680, conditioning tokens 682, multi-layer perceptron (MLP) 684, post-normalization first scaling and shifting parameters 686, first scaling parameter 688, post-normalization second scaling and shifting parameters 690, and second scaling parameter 692. In some embodiments, the architecture uses a Latent Diffusion Transformer 694. In some embodiments, DiT Block 696 uses an “adaLN-Zero” technique.

Diffusion Transformers (DiTs) is a popular architecture for diffusion models and is designed to be structurally faithful to standard transformer architecture. DiT incorporates transformer structures' scaling properties. For training denoising diffusion probabilistic models (DDPMs) of images (e.g., spatial representations of images), DiT is based on a Vision Transformer (ViT) architecture which operates on sequences of patches. DiT processes images by dividing them into patches, converting these patches into tokens, and applying attention mechanisms to model relationships between different regions of the image. This approach allows the model to capture both local and long-range dependencies in the image generation process.

In some cases, input to DiT is a spatial representation z. For 256×256×3 images, z has shape 32×32×4. A first layer of a DiT is to carry out patchify operation, where the DiT divides an input image into patches and converts the patches (a form of spatial input) into a sequence of T tokens, each of dimension d, by linearly embedding each patch in the input. Following the patchify process, ViT frequency-based positional embeddings are applied to all input tokens. In some cases, the number of tokens T created by patchify is determined by a patch size hyperparameter p. In some cases, T=(I/p)², where/is another shape parameter, thus halving p will quadruple T, which in some cases at least quadruples total of transformer Giga Floating Point Operations (Gflops). Accordingly, embodiments herein can increase inference speed by configuring and operating within a highly compressed latent space, resulting in fewer processed tokens relative to higher spatial dimension (e.g., H×W) spaces. In some examples, changing p has no impact on downstream parameter counts, i.e., parameter counts in downstream layers of DiT is independent from p. In some examples, p=2, 4 or 8. Various patch sizes, transformer block architectures and model sizes are implemented.

Following Patchify operation, attention mechanisms are applied to model relationships between different regions of the image in one or more DiT blocks. In addition to noised image inputs, diffusion models sometimes process additional conditional information such as noise timesteps t, class labels c, natural language information, etc. Four variants of transformer blocks for processing conditional inputs including both input information and conditional information are described below.

In some cases, DiT blocks in the DiT network are implemented using adaptive layer norm (adaLN) blocks. Following adaptive normalization layers in generative adversarial networks (GANs) and conventional diffusion models with U-Net backbones, in some examples, standard normalization layers in transformer blocks are replaced with adaptive layer norm (adaLN). Rather than directly learning dimension-wise scale γ and shift parameters β, in adaLN the system regresses γ and β from a sum of the embedding vectors of the noise timesteps t and the class labels c. An adaLN adds relatively small numbers of Gflops and is more efficient. Additionally, adaLN is a conditioning mechanism that applies a same function to all tokens.

In some cases, DiT blocks in the DiT network are implemented using adaLN-Zero blocks, which leverages zero-initialization techniques. In Residual Networks (ResNets), initializing each residual block as the identity function x→x is beneficial. In some examples, zero-initializing a final batch norm scale factor γ in each block accelerates large-scale training in supervised learning settings. Diffusion models based on U-Nets use a similar initialization strategy, zero-initializing final convolutional layer in each block prior to residual connections. An adaLN-Zero block is modified from an adaLN block using similar zero-initialization techniques. In addition to regressing the dimension-wise scale γ and the shifting parameters β, the system also regresses dimension-wise scaling parameters as that are applied immediately prior to residual connections within the DiT block. The network initializes a multi-layer perceptron (MLP) to output a zero-vector for all αs; this initializes an entire DiT block as the identity function. As with the adaLN block, adaLNZero adds negligible Gflops to the model.

In some cases, DiT blocks in the DiT network are implemented using in-context conditioning, where vector embeddings of t and c are appended as two additional tokens in the input sequence, and after a final block, the network removes the two conditioning tokens from the sequence.

In some cases, DiT blocks in the DiT network include cross-attention blocks. The DiT network concatenates the embeddings of t and c into a length-two sequence, separate from the image token sequence. The transformer block is modified to include an additional multi-head cross-attention layer following the multi-head self-attention block.

In some cases, the DiT network includes a sequence of N DiT blocks, each operating at a hidden dimension size d. Following ViT, the DiT network uses standard transformer configs that jointly scale N, d and attention heads. In some examples, Small(S), Base (B), Large (L) variants, XLarge (XL) variants of model sizes are implemented. Small or Base model sizes have N=12 layers of DiT blocks, Large model sizes have 24 layers of DiT blocks. XLarge model sizes have 28 layers of DiT blocks.

After a final DiT block, the DiT network decodes the sequence of image tokens into an output noise prediction and an output diagonal covariance prediction. Both outputs have shape equal to an original spatial input. Standard linear decoder is utilized to decode, wherein a final normalization layer (or adaptive normalization layer if the DiT block is an adaLN block) and linearly decode each token into a p×p×2C tensor, where C is a number of channels in the spatial input to the DiT network and p is the patch size hyperparameter. Finally, decoded tokens are rearranged into their original spatial layout to get the predicted noise and covariance.

The architecture 600, in some cases, uses a Latent Diffusion Transformer 694. The architecture 600 processes noised latent 640, which may be a noised version of an input image encoded in a latent space. Patchify operation 630 divides the noised latent into a sequence of patches that are processed as tokens. The tokens are vector representations of each patch of the image in latent space and are adjusted through attention processes. Each of the tokens also receives timestep information 645 and label information 650 and, accordingly, their embedding 635, which encodes the current denoising timestep and class labels as conditional information. In some cases, embedding 635 is referred to as conditional embedding or conditional information embedding. In some cases, a positional embedding which encodes each token's spatial position in the image is applied to the patchified input tokens at the patchify operations 630. In some examples the positional embedding is ViT frequency-based positional embedding. The input tokens 680 generated by the patchify operation 630 and the conditioning tokens 682 generated by the embedding 635 are processed through N DiT block(s) 625, where N may be 62, 24 or 28. Other values of N may be used. In some cases, conditional tokens refer to tokens generated based on embedding 635 encoding timestep information 645 and label information 650.

Each of the DiT block(s) 625 includes multiple processing stages. DiT Block 696 illustrates an embodiment of one block in the DiT block(s) 625. In some embodiments, the DiT Block 696 is an example of, or includes aspects of, the adaLN-Zero block. In some cases, input tokens 680 interact with the conditioning tokens 682 through multiple attention mechanisms. Particularly, after first normalization 678 applied to the input tokens and MLP 684 to the conditional tokens, MLP 684 generates or updates post-normalization first scaling and shifting parameters 686, denoted as γ₁, β₁, for post-normalization first scaling and shifting 676 to scale and shift the output of first normalization 678 accordingly. As the normalized input tokens obtained from first normalization 678 are scaled and shifted at post-normalization first scaling and shifting 676 using the conditional information carried as least in β₁, β₁, this allows the input information and conditional information to interact. Self-attention 674 allows the scaled and shifted normalized input tokens, namely the output from post-normalization first scaling and shifting 676, to attend to each other. MLP 684 also generates or updates first scaling parameter 688 denoted as α₁ for first scaling operations 672 to scale the output of self-attention 674 (e.g., multi-head self-attention), further interacting the input information and conditional information. The input tokens 680 is then summed with the output of first scaling operations 672 at first residual connection 670. In some examples, α₁ has initial values 0, and the DiT Block 696 is initialized as the identity function.

A similar process is performed in a second half of the DiT Block 696. MLP 684 generates or updates post-normalization second scaling and shifting parameters 690, denoted as γ₂, β₂, for post-normalization second scaling and shifting 666 to scale and shift the output of second normalization 668 accordingly. As the output from second normalization 668 is scaled and shifted using the conditional information carried at least in γ₂, β₂, this allows the input information and conditional information to further interact. Feed-forward network 664 then processes the scaled and shifted output from post-normalization second scaling and shifting 666. MLP 684 also generates or updates second scaling parameter 692 denoted as α₂ for second scaling operations 662 to scale the output of feed-forward network 664, further interacting the input information and conditional information. In some cases, the feed-forward network 664 is a pointwise feed-forward network. The output from first residual connection 670 is then summed with the output of second scaling operations 662 at second residual connection 660, and the result is the final output of DiT Block 696. In some examples, α₂ has initial values 0, and the DiT Block 696 is initialized as the identity function. This process repeats for each DiT block in the sequence.

After processing through all DiT block(s) 625, the outputs undergo normalization layer 620 followed by linear and reshape layers 615. The final output is the predicted noise 605, which represents the model's prediction of the noise that was added to initially create the noised latent 640, and the predicted covariance 610, which represents the model's prediction of the covariance. The predicted noise 605 is removed from noised latent 640 at each diffusion timestep, and the predicted covariance may affect how noise is removed or resampled in the reverse or denoising process. At the end of the denoising schedule, the latent sample is decoded to generate the synthetic image in pixel space.

FIG. 7 shows an example of an operation of an image encoder according to aspects of the present disclosure. The example shown includes input image 700, image segmentation 705, masking 710, body parsing 715, grouping 720, body part detection 725, cropping 730, body images 735, image encoder 740, and body part image embeddings 745.

Input image 700 is an example of, or includes aspects of, the corresponding element described with reference to FIGS. 1, 9, 11, and 12. Image encoder 740 is an example of, or includes aspects of, the corresponding element described with reference to FIGS. 2 and 9. Body part image embeddings 745 is an example of, or includes aspects of, the corresponding element described with reference to FIGS. 8 and 9.

In this example, the system processes an input image 700 to identify and encode different body regions of a subject. The system first performs image segmentation 705 and masking 710 to identify the pixels corresponding to the subject and the remaining pixels, which may correspond to a background region. The subject is then passed to a body parsing model that identifies different body regions and groups them into N−1 categories. This results in an input set of the individual, X∈ [symbol] ^{N×H×W×3}, comprising one full-body image and N−1 body part images. The value of N can represent any number of body regions. In one or more embodiments, N is empirically set to 5, corresponding to the full body, face, torso, legs, and shoes. These regions may include face, torso, legs, and shoes. The system performs body part detection 725 to extract bounding box coordinates for each category.

The system then performs cropping 730 of the corresponding regions from the input image 700. During this process, the system may apply zero-padding along the largest side to preserve image scale and resize the cropped regions to the original input size. This results in a set of body images 735 comprising one full-body image and N−1 body part images.

Image encoder 740 processes each body image independently to generate body part image embeddings 745. The image encoder may use a pre-trained vision transformer that captures fine-grained, localized features including structural and texture information. Embodiments may preserve spatial information from the input by utilizing the full set of local tokens rather than just a class token. For example, the input set X is encoded into a set of image features F∈ [symbol] ^{N×h×w×d}^{_{F}}, where h, w, and d_{F} represent the height, width, and channel dimensions of each feature, respectively. The resulting body part image embeddings 745 contain detailed appearance information for each body region and are used as input to the body-partitioned transformer for further processing.

FIG. 8 shows an example of an operation of a body-partitioned transformer 810 according to aspects of the present disclosure. The example shown includes body part image embeddings 800, initial body part embeddings 805, body-partitioned transformer 810, body part identity embeddings 835, and stacked identity embedding 840.

Body part image embeddings 800 is an example of, or includes aspects of, the corresponding element described with reference to FIGS. 7 and 9. Body-partitioned transformer 810 is an example of, or includes aspects of, the corresponding element described with reference to FIGS. 2 and 9. Stacked identity embedding 840 is an example of, or includes aspects of, the corresponding element described with reference to FIG. 9. In one aspect, body-partitioned transformer 810 includes cross-attention 815, self-attention 820, MLP 825, and iterations multiplier 830.

To map the input features from an image encoder onto a pre-trained T2I (Text-to-Image) model, a conventional approach involves using Multi-Layer Perceptron (MLP) layers. However, employing an MLP alone is insufficient to capture key visual attributes from complex input features, particularly from in-the-wild human images. This approach tends to blend local details across the body into a global appearance. To address these limitations, embodiments employ a body-partitioned transformer. This decoder projects local features from each body region into corresponding dense identity embeddings, thereby preserving detailed visual appearance. Each transformer layer comprises a cross-attention layer, a self-attention layer, and an MLP layer.

In the example shown in FIG. 8, the body-partitioned transformer 810 processes body part image embeddings 800 to generate body part identity embeddings 835. The system begins with initial body part embeddings 805, which are learnable hidden embeddings whose dimensions match those of the output identity embeddings. These initial embeddings have a token length that equals the height times width of the feature map from the image encoder, which allows for dense representation that preserves fine-grained details.

For each body part image and its corresponding embedding, the body-partitioned transformer 810 performs multiple iterations of processing. In each iteration, the cross-attention 815 links the hidden embeddings to their corresponding features from the body part image embeddings 800. The output from cross-attention 815 is then passed to self-attention 820, which learns internal relationships within the embedding. The self-attention layer projects the normalized cross-attention output as queries, keys, and values. This operation allows the model to refine associations between different elements within each body part representation. Each component (cross-attention, self-attention, and MLP) includes residual connections that add the input to the output, helping maintain information flow through the network. After processing, the updated embeddings serve as input to the next iteration, indicated by iterations multiplier 830. The sequence of attention operations as well as the MLP pass performed in each iteration may be represented by:

$${H}_{ca}^{i , j} = C\_Att ( LN ( {H}^{i , j} ) , {F}^{i} , {F}^{j} ) + {H}^{i , j} \qquad ( 3 )$$

$${H}_{s a}^{i , j} = S\_Att ( LN ( {H}_{c a}^{i , j} ) , LN ( {H}_{c a}^{i , j} ) , LN ( {H}_{c a}^{i , j} ) ) + {H}_{c a}^{i , j} \qquad ( 4 )$$

$${H}^{i , j + 1} = MLP ( LN ( {H}_{s a}^{i , j} ) ) + {H}_{s a}^{i , j} \qquad ( 5 )$$

where

$${H}_{c a}^{i , j}$$

represents the cross-attention output for the i-th body part at the j-th iteration, C_Att represents the cross-attention function, LN represents layer normalization, H^{i,j} represents the input hidden embedding, and Fⁱ represents the feature from the i-th body part image. S_Att denotes the self-attention layer, where

$$LN ( {H}_{c a}^{i , j} )$$

is projected as the queries, keys, and values. MLP refers to the multi-layer perceptron layer. After M iterations, refined identity embeddings C_{H}∈ [symbol] ^{N×I}^{_{H}}^{×d}^{_{H}} are obtained.

After completing all iterations, the system produces refined body part identity embeddings 835 for each body region. These embeddings are then concatenated along the token length dimension to form a stacked identity embedding 840

$${C}_{H}^{*} .$$

This concatenation can be expressed as:

$${C}_{H}^{*} = Concat ( [ {C}_{H}^{1} , … , {C}_{H}^{N} ] ) ∈ {ℝ}^{( N \times {l}_{H} ) \times {d}_{H}} \qquad ( 6 )$$

where Concat(⋅) represents the concatenation operation,

$${C}_{H}^{*}$$

accordingly is a full representation of the subject's visual identity across all body regions and may be used to condition the image generation model.
Generating Images with Full-Body Preservation

FIG. 9 shows an example of an image generation pipeline according to aspects of the present disclosure. The example shown includes input image 900, image encoder 905, body part image embeddings 910, body-partitioned transformer 915, stacked identity embedding 920, input text 925, text encoder 930, text embedding 935, body part cross-attention block 940, context-free guidance (CFG) parameter 945, text cross-attention block 950, denoising model 955, partially denoised image 960, and synthetic image 965.

Input image 900 is an example of, or includes aspects of, the corresponding element described with reference to FIGS. 1, 7, 11, and 12. Image encoder 905 is an example of, or includes aspects of, the corresponding element described with reference to FIGS. 2 and 7. Body part image embeddings 910 is an example of, or includes aspects of, the corresponding element described with reference to FIGS. 7 and 8. Body-partitioned transformer 915 is an example of, or includes aspects of, the corresponding element described with reference to FIGS. 2 and 8.

Stacked identity embedding 920 is an example of, or includes aspects of, the corresponding element described with reference to FIG. 8. Input text 925 is an example of, or includes aspects of, the corresponding element described with reference to FIG. 1. Text encoder 930 is an example of, or includes aspects of, the corresponding element described with reference to FIG. 2. Body part cross-attention block 940 is an example of, or includes aspects of, the corresponding element described with reference to FIG. 2. Text cross-attention block 950 is an example of, or includes aspects of, the corresponding element described with reference to FIG. 2.

The following will describe the full generative pipeline of the system. The input image 900 is provided to image encoder 905, which segments the image into body regions and encodes each region independently. This process produces body part image embeddings 910, which capture localized visual information from each body region. These embeddings are then processed by body-partitioned transformer 915, which applies multiple iterations of cross-attention, self-attention, and MLP operations to generate refined identity embeddings for each body part. These refined embeddings are concatenated to form stacked identity embedding 920.

According to some aspects, the system processes input text 925 describing the desired scene is processed by text encoder 930 to produce text embedding 935 in parallel with the generation of the stacked identity embedding 920. This embedding captures the semantic meaning of the scene description and guides the overall composition of the synthetic image. A scene may include scenic or background elements, actions or poses for the subject to perform, stylistic/aesthetic customizations (e.g. “cartoon”, “anime”, “abstract”), descriptions of different views, or the like.

Denoising model 955 starts with a noise input and progressively refines it to generate a synthetic image. During this denoising process, body part cross-attention block 940 enables the model to attend to specific body part features when generating corresponding regions in the output image. For example, given

$${C}_{H}^{*} ,$$

a pre-trained T2I model ϵ_{θ}(⋅) portrays the target image Y, aligned with the text embedding C_{T} derived from text prompt T. Embodiments may utilize a decoupled cross-attention mechanism to process the text and the body part identity embeddings.

$${C}_{H}^{*}$$

is processed through an additional learn-able identity cross-attention module, where target queries Q_{Y} for Y attend to keys

$${K}_{H}^{*}$$

and values

$${V}_{H}^{*}$$

projected from

$${C}_{H}^{*} .$$

The text embedding C_{T}∈ [symbol] ^{l}^{_{T}}^{×d}^{_{T}} is incorporated through the text cross-attention module, projected as keys K_{T} and values V_{T}, where l_{T} and d_{T} denote the token length and the channel dimension, respectively. The output Z′ is formulated as:

$${Z}^{′} = C\_Att ( {Q}_{Y} , {K}_{T} , {V}_{T} ) + λ \cdot C - Att ( {Q}_{Y} , {K}_{H}^{*} , {V}_{H}^{*} ) \qquad ( 7 )$$

where is the text or identity cross-attention module, and λ is the weighting scalar (e.g. context-free guidance (CFG) parameter 945).

During system training, the parameters of body-partitioned transformer 915, the initial body part identity embeddings (not shown in this figure), and body part cross-attention block 940 may be trained while parameters of the other ML-based models are held fixed. This targeted training approach preserves the generative capabilities of the pre-trained text-to-image model while enabling effective identity preservation. Additional detail regarding the training process is provided with reference to FIG. 13.

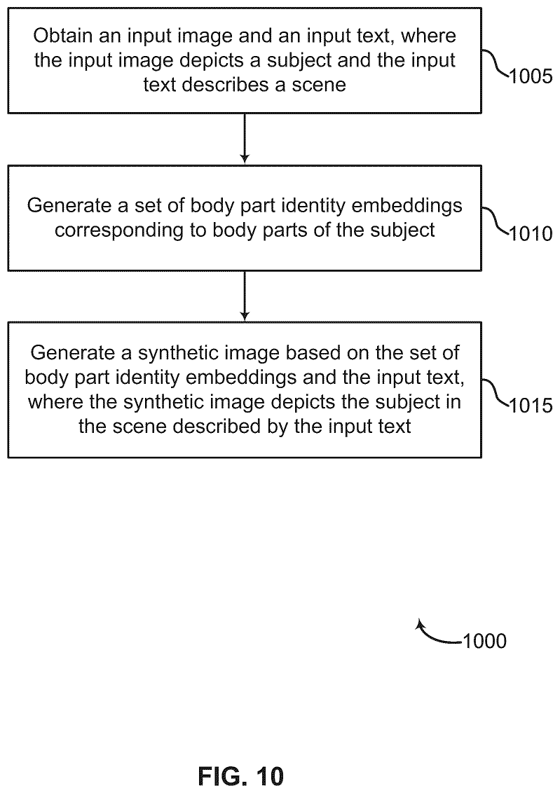

FIG. 10 shows an example of a method 1000 for generating a synthetic image of a subject with full-body preservation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1005, the system obtains an input image and an input text, where the input image depicts a subject and the input text describes a scene. The input image may be a photograph or digital rendering of a person, showing their face, clothing, accessories, and other distinctive visual characteristics. The input text describes a scene in which to place the subject. A scene may include scenic or background elements, actions or poses for the subject to perform, stylistic or aesthetic customizations (e.g., “cartoon”, “anime”, “abstract”), descriptions of different views, or similar contextual information. In some cases, the operations of this step refer to, or may be performed by, an image processing apparatus as described with reference to FIGS. 1 and 2.

At operation 1010, the system generates a set of body part identity embeddings corresponding to body parts of the subject. These embeddings are dense numerical representations that encode visual characteristics of specific body regions of the subject. The system may segment the input image to isolate different body regions such as the face, torso, legs, and shoes. Each region is processed independently to capture localized appearance information including clothing patterns, textures, colors, and distinctive features. The body-partitioned transformer applies cross-attention operations to map these features to corresponding identity tokens and self-attention operations to refine the relationships between features. This approach preserves fine-grained details while maintaining spatial relationships across the subject's full appearance. In some cases, the operations of this step refer to, or may be performed by, a body-partitioned transformer as described with reference to FIGS. 2, 8, and 9.

At operation 1015, the system generates a synthetic image based on the set of body part identity embeddings and the input text, where the synthetic image depicts the subject in the scene described by the input text. The system uses a text-to-image generation model that has been conditioned on both the body part identity embeddings and the text embedding. The body part cross-attention allows the model to preserve the subject's visual identity across different contexts, while the text cross-attention guides the overall scene composition. The resulting synthetic image shows the same subject with consistent appearance features, including facial identity, clothing, and accessories, placed within the new scene described by the input text. In some cases, the operations of this step refer to, or may be performed by, an image generation model as described with reference to FIG. 2.

### Results

FIG. 11 shows an example of results of various text prompts and a single input image 1100 according to aspects of the present disclosure. The example shown includes input image 1100, first result 1105, second result 1110, and third result 1115. Input image 1100 is an example of, or includes aspects of, the corresponding element described with reference to FIGS. 1, 7, 9, and 12.

Input image 1100 depicts a person with long hair, a hat, a dress with a floral pattern, and braided shoes. First result 1105, second result 1110, and third result 1115 depict the results of providing input image 1100 to an image processing system according to embodiments of the present disclosure along with various input prompts. The first input prompt describes the subject planting flowers and in a kneeling pose. As apparent from the Figure, the subject retains the identifiable characteristics depicted in the input image, including facial features, clothing, and accessories. Second result 1110 and third result 1115 similarly place the subject in different environments and scenes while retaining the full-body identity.

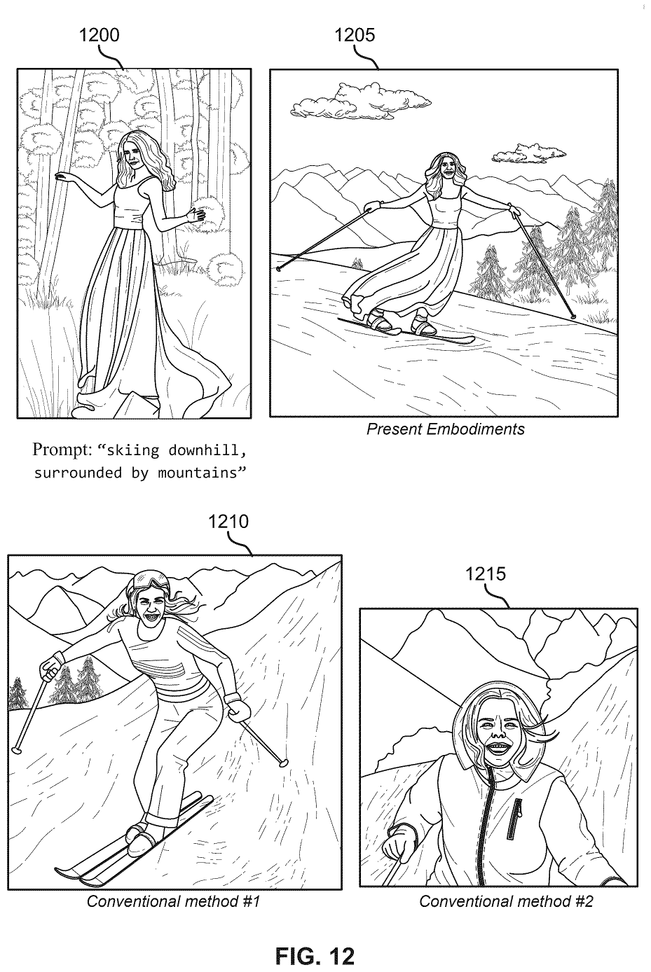

FIG. 12 shows an example of comparative results according to aspects of the present disclosure. The example shown includes input image 1200, synthetic image from present embodiments 1205, synthetic image from first conventional method 1210, and synthetic image from second conventional method 1215. Input image 1200 is an example of, or includes aspects of, the corresponding element described with reference to FIGS. 1, 7, 9, and 11.

Input image 1200 depicts the subject from FIG. 11 with slightly changed attire, for example, without a hat. The same prompt “skiing downhill, surrounded by mountains” is provided to the image processing system of the present disclosure as well as two other conventional methods for generating images depicting subjects. As apparent from the Figure, while the conventional methods successfully generate an image of a person skiing downhill and surrounded by mountains, they do not faithfully reproduce the full-body identity of the person depicted in input image 1200. For example, synthetic image from first conventional method 1210 adds additional headgear to the person and changes the clothing from a dress to pants and a shirt. The synthetic image from second conventional method 1215 further gets it wrong by adding a thick upper jacket to the person. The conventional approaches, which include generative denoising diffusion models with adapter networks, are unable to capture the full-body identity of the person from input image 1200, in contrast with the present embodiments which generate synthetic image from present embodiments 1205. Synthetic image from present embodiments 1205 retains the identifiable facial features, clothing, and accessories as depicted in input image 1200.

### Training

In some embodiments, the body-partitioned transformer decoder and the body part cross-attention module are trained during a training phase while all other parameters are frozen, including parameters of the image encoder (e.g. the segmentation model, a body parsing model, and the image encoding model), and text-to-image (T2I) generative diffusion model. In an example training phase, embodiments utilize a paired human dataset such as Visual Persona-500k. An input set of the individual, X, guides the frozen diffusion model ϵ_{θ}(⋅) to generate another image of the same individual, Y, aligned with the target prompt T. The training objective is formulated by minimizing the prediction error L:

$$L := {𝔼}_{{𝒵}_{Y} , t , ϵ , {C}_{T} , {C}_{H}^{*}} [ {‖ ϵ - {ϵ}_{θ} ( {𝒵}_{Y} , t , ϵ , {C}_{T} , {C}_{H}^{*} ) ‖}_{2}^{2} ] \qquad ( 8 )$$

where ϵ is the added noise in the forward pass and Z_{Y}, t represents the noisy latent variable of Y at time step t. L is backpropagated through the diffusion model to update the parameters in the body-partitioned transformer and the body part cross-attention module. It is noted that in some cases, training the models on identical images for X and Y may lead to overfitting on identity-unrelated elements like background, lighting, and composition.

FIG. 13 is a flow diagram depicting an algorithm as a step-by-step procedure 1300 in an example implementation of operations performable for training a machine-learning model. The procedure 1300 provides one or more examples of generating training data, use of the training data to train a machine-learning model, and use of the trained machine-learning model to perform a task.

To begin in this example, a machine-learning system collects training data (block 1302) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1304) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1306). Initialization of the machine-learning model includes selecting a model architecture (block 1308) to be trained. Examples of model architectures include neural networks, convolutional neural networks (CNNs), long short-term memory (LSTM) neural networks, transformer networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1310). The loss function is utilized to measure a difference between an output of the machine-learning model (i.e., predictions) and target values (e.g., as expressed by the training data) to be used to train the machine-learning model. Additionally, an optimization algorithm is selected (1312) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1314) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1318) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1320), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1320), the procedure 1300 continues training of the machine-learning model using the training data (block 1318) in this example.

If the stopping criterion is met (“yes” from decision block 1320), the trained machine-learning model is then utilized to generate an output based on subsequent data (block 1322). The trained machine-learning model, for instance, is trained to perform a task as described above and therefore, once trained is configured to perform that task based on subsequent data received as an input and processed by the machine-learning model.

FIG. 14 shows an example of a method 1400 for training a diffusion model according to aspects of the present disclosure. In some embodiments, the method 1400 describes an operation for configuring the image generation model 245 as described with reference to FIG. 2, and particularly the body part cross-attention block 250. In some examples, these operations are performed by a system including a processor executing a set of codes to control functional elements of an apparatus, such as the guided diffusion model described in FIG. 4.

Additionally or alternatively, certain processes of method 1400 may be performed using special-purpose hardware. Generally, these operations are performed according to the methods and processes described in accordance with aspects of the present disclosure. In some cases, the operations described herein are composed of various substeps or are performed in conjunction with other operations.

At operation 1405, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1410, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 1415, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 1420, the system compares predicted image (or image features) at stage n−1 to an actual image (or image features), such as the image at stage n−1 or the original input image. For example, given observed data x, the diffusion model may be trained to minimize the variational upper bound of the negative log-likelihood-log pe (x) of the training data.

At operation 1425, the system updates parameters of the model based on the comparison. For example, parameters of a U-Net or a DiT may be updated using gradient descent. Time-dependent parameters of the Gaussian transitions can also be learned.

FIG. 15 shows an example of a computing device 1500 according to aspects of the present disclosure. The example shown includes computing device 1500, processor(s) 1505, memory subsystem 1510, communication interface 1515, I/O interface 1520, user interface component(s), and channel 1530.

In some embodiments, computing device 1500 is an example of, or includes aspects of, an image processing apparatus as described in FIGS. 1 and 2. In some embodiments, computing device 1500 includes one or more processors 1505 are configured to execute instructions stored in memory subsystem 1510 obtain an input image and an input text, wherein the input image depicts a subject and the input text describes a scene; generate, using a body-partitioned transformer of an image generation model, a plurality of body part identity embeddings corresponding to body parts of the subject; and generate, using the image generation model, a synthetic image based on the plurality of body part identity embeddings and the input text, wherein the synthetic image depicts the subject in the scene described by the input text.

According to some aspects, computing device 1500 includes one or more processors 1505. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store model parameters in the form of tensors which, when combined with mathematical operations such as matrix multiplications, implement machine learning models specially configured to perform specific tasks. These parameters may correspond to the models described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1515 operates at a boundary between communicating entities (such as computing device 1500, one or more user devices, a cloud, and one or more databases) and channel 1530 and can record and process communications. In some cases, communication interface 1515 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1520 is controlled by an I/O controller to manage input and output signals for computing device 1500. In some cases, I/O interface 1520 manages peripherals not integrated into computing device 1500. In some cases, I/O interface 1520 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1520 or via hardware components controlled by the I/O controller.

According to some aspects, user interface component(s) 1525 enable a user to interact with computing device 1500. In some cases, user interface component(s) 1525 include an audio device, such as an external speaker system, an external display device such as a display screen, an input device (e.g., a remote control device interfaced with a user interface directly or through the I/O controller), or a combination thereof. In some cases, user interface component(s) 1525 include a GUI.

Accordingly, the present disclosure includes the following aspects.

A method for image generation is described. One or more aspects of the method include obtaining an input image and an input text, wherein the input image depicts a subject and the input text describes a scene; generating, using a body-partitioned transformer of an image generation model, a plurality of body part identity embeddings corresponding to body parts of the subject; and generating, using the image generation model, a synthetic image based on the plurality of body part identity embeddings and the input text, wherein the synthetic image depicts the subject in the scene described by the input text.

Some examples of the method, apparatus, non-transitory computer readable medium, and system further include segmenting the input image to obtain a plurality of body part images, wherein the plurality of body part identity embeddings are generated based on the plurality of body part images, respectively. Some examples further include obtaining a plurality of pretrained body part embeddings, wherein the plurality of body part identity embeddings are generated based on the plurality of pretrained body part embeddings, respectively.

Some examples of the method, apparatus, non-transitory computer readable medium, and system further include performing a body part cross-attention operation based on the plurality of body part identity embeddings, wherein the synthetic image is generated based on an output of the body part cross-attention operation. Some examples further include performing a text cross-attention operation based on the input text, wherein the synthetic image is generated based on an output of the text cross-attention operation.

Some examples of the method, apparatus, non-transitory computer readable medium, and system further include obtaining a noise input. Some examples further include denoising the noise input based on the input text and the plurality of body part identity embeddings. Some examples further include obtaining an additional input image depicting an additional subject. Some examples further include generating, using the body-partitioned transformer, an additional plurality of body part identity embeddings corresponding to body parts of the additional subject, wherein the synthetic image depicts the additional subject. In some aspects, the image generation model is trained by segmenting a training input image into a plurality of training body part images.

A method for image generation is described. One or more aspects of the method include obtaining an input image and an input text, wherein the input image depicts a subject and the input text describes a scene; performing a body part cross-attention operation based on the input image; performing a text cross-attention operation based on the input text; and generating, using an image generation model, a synthetic image based on an output of the body part cross-attention operation and an output of the text cross-attention operation, wherein the synthetic image depicts the subject in the scene described by the input text.

Some examples of the method, apparatus, non-transitory computer readable medium, and system further include generating, using a body-partitioned transformer of the image generation model, a plurality of body part identity embeddings corresponding to body parts of the subject, wherein the body part cross-attention operation is based on the plurality of body part identity embeddings. Some examples further include segmenting the input image to obtain a plurality of body part images, wherein the plurality of body part identity embeddings are generated based on the plurality of body part images, respectively.

Some examples of the method, apparatus, non-transitory computer readable medium, and system further include obtaining a plurality of pretrained body part embeddings, wherein the plurality of body part identity embeddings are generated based on the plurality of pretrained body part embeddings, respectively. Some examples further include obtaining a noise input. Some examples further include denoising the noise input based on the input text and the input image. Some examples further include obtaining an additional input image depicting an additional subject. Some examples further include generating, using a body-partitioned transformer of the image generation model, an additional plurality of body part identity embeddings corresponding to body parts of the additional subject, wherein the synthetic image depicts the additional subject.

An apparatus for image generation is described. One or more aspects of the apparatus include a memory component; a processing device coupled to the memory component, the processing device configured to perform operations comprising: obtaining an input image and an input text, wherein the input image depicts a subject and the input text describes a scene; generating, using a body-partitioned transformer of an image generation model, a plurality of body part identity embeddings corresponding to body parts of the subject; and generating, using the image generation model, a synthetic image based on the plurality of body part identity embeddings and the input text, wherein the synthetic image depicts the subject in the scene described by the input text.

Some examples of the apparatus, system, and method further include a body part cross-attention block configured to perform a body part cross-attention operation based on the input image. Some examples of the apparatus, system, and method further include a text cross-attention block configured to perform a text cross-attention operation based on the input text.

In some aspects, the image generation model comprises a denoising diffusion model. Some examples of the apparatus, system, and method further include an image encoder configured to generate a body part image embedding based on a body part image. Some examples of the apparatus, system, and method further include a text encoder configured to generate a text embedding based on the input text.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input image and an input text, wherein the input image depicts a subject and the input text describes a scene;
generating, using a body-partitioned transformer of an image generation model, a plurality of body part identity embeddings corresponding to body parts of the subject; and
generating, using the image generation model, a synthetic image based on the plurality of body part identity embeddings and the input text, wherein the synthetic image depicts the subject in the scene described by the input text.

2. The method of claim 1, wherein generating the plurality of body part identity embeddings comprises:
segmenting the input image to obtain a plurality of body part images, wherein the plurality of body part identity embeddings are generated based on the plurality of body part images, respectively.

3. The method of claim 1, wherein generating the plurality of body part identity embeddings comprises:
obtaining a plurality of pretrained body part embeddings, wherein the plurality of body part identity embeddings are generated based on the plurality of pretrained body part embeddings, respectively.

4. The method of claim 1, wherein generating the synthetic image comprises:
performing a body part cross-attention operation based on the plurality of body part identity embeddings, wherein the synthetic image is generated based on an output of the body part cross-attention operation.

5. The method of claim 1, wherein generating the synthetic image comprises:
performing a text cross-attention operation based on the input text, wherein the synthetic image is generated based on an output of the text cross-attention operation.

6. The method of claim 1, wherein generating the synthetic image comprises:
obtaining a noise input; and
denoising the noise input based on the input text and the plurality of body part identity embeddings.

7. The method of claim 1, further comprising:
obtaining an additional input image depicting an additional subject; and
generating, using the body-partitioned transformer, an additional plurality of body part identity embeddings corresponding to body parts of the additional subject, wherein the synthetic image depicts the additional subject.

8. The method of claim 1, wherein:
the image generation model is trained by segmenting a training input image into a plurality of training body part images.

9. A non-transitory computer readable medium storing code, the code comprising instructions that, when executed by at least one processor, cause the at least one processor to perform operations comprising:
obtaining an input image and an input text, wherein the input image depicts a subject and the input text describes a scene;
performing a body part cross-attention operation based on the input image;
performing a text cross-attention operation based on the input text; and
generating, using an image generation model, a synthetic image based on an output of the body part cross-attention operation and an output of the text cross-attention operation, wherein the synthetic image depicts the subject in the scene described by the input text.

10. The non-transitory computer readable medium of claim 9, the code further comprising instructions that, when executed by the at least one processor, cause the at least one processor to perform operations comprising:
generating, using a body-partitioned transformer of the image generation model, a plurality of body part identity embeddings corresponding to body parts of the subject, wherein the body part cross-attention operation is based on the plurality of body part identity embeddings.

11. The non-transitory computer readable medium of claim 10, wherein generating the plurality of body part identity embeddings comprises:
segmenting the input image to obtain a plurality of body part images, wherein the plurality of body part identity embeddings are generated based on the plurality of body part images, respectively.

12. The non-transitory computer readable medium of claim 10, wherein generating the plurality of body part identity embeddings comprises:
obtaining a plurality of pretrained body part embeddings, wherein the plurality of body part identity embeddings are generated based on the plurality of pretrained body part embeddings, respectively.

13. The non-transitory computer readable medium of claim 9, wherein generating the synthetic image comprises:
obtaining a noise input; and
denoising the noise input based on the input text and the input image.

14. The non-transitory computer readable medium of claim 9, the code further comprising instructions that, when executed by the at least one processor, cause the at least one processor to perform operations comprising:
obtaining an additional input image depicting an additional subject; and
generating, using a body-partitioned transformer of the image generation model, an additional plurality of body part identity embeddings corresponding to body parts of the additional subject, wherein the synthetic image depicts the additional subject.

15. A system for image processing, comprising:
a memory component;
a processing device coupled to the memory component, the processing device configured to perform operations comprising:
obtaining an input image and an input text, wherein the input image depicts a subject and the input text describes a scene;
generating, using a body-partitioned transformer of an image generation model, a plurality of body part identity embeddings corresponding to body parts of the subject; and
generating, using the image generation model, a synthetic image based on the plurality of body part identity embeddings and the input text, wherein the synthetic image depicts the subject in the scene described by the input text.

16. The system of claim 15, the system further comprising:
a body part cross-attention block configured to perform a body part cross-attention operation based on the input image.

17. The system of claim 15, the system further comprising:
a text cross-attention block configured to perform a text cross-attention operation based on the input text.

18. The system of claim 15, wherein:
the image generation model comprises a denoising diffusion model.

19. The system of claim 15, the system further comprising:
an image encoder configured to generate a body part image embedding based on a body part image.

20. The system of claim 15, the system further comprising:
a text encoder configured to generate a text embedding based on the input text.
